(19) United States
(12) Patent Application Publication
(10) Pub. No.: US 2016/0117644 A1
(43) Pub. Date: Apr. 28, 2016

(54) SYSTEM AND METHOD FOR BUSINESS PROCESS AUTOMATION FOR FINANCIAL ADVISORS

(71) Applicant: StratiCo LLC, Elk Grove, CA (US)

(72) Inventor: Bradley Harsch, Elk Grove, CA (US)

(21) Appl. No.: 14/521,408

(22) Filed: Oct. 22, 2014

(51) Int. Cl. G06Q 10/10; G06Q 40/00

(52) U.S. Cl. CPC G06Q 10/1095; G06Q 40/00

(57) ABSTRACT

A system and method for business process automation for financial advisors are disclosed. A particular embodiment includes: generating, by a data processor, a user interface for a user at a user platform; presenting to the user, by use of the user interface, a plurality of activities associated with a plurality of clients; enabling the user to create a new activity for one of the plurality of clients, the activity including an associated activity date; notifying the user when the activity becomes due based on the activity date; and presenting to the user, by use of the user interface, a view of an aggregation of key client performance metrics summarized in corresponding graphic images, the key client performance metrics including a plurality of different dimensions to inform the user of a current level of performance of an aggregate of the user's clients in each of the plurality of different dimensions, the plurality of different dimensions including an interaction dimension that measures the user's responsiveness to the plurality of activities associated with the plurality of clients.

### TECHNICAL FIELD

This patent application relates to computer-implemented software and networked systems, according to one embodiment, and more specifically to a system and method for business process automation for financial advisors.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012-2014 StratiCo LLC, All Rights Reserved.

### BACKGROUND

Electronic information processing and communication systems are playing an increasingly important role in coordinating business operations among various participants in a community (e.g., the financial community). Among other functions, these technologies may be utilized for coordinating administrative operations, disseminating information or documents for review and retention, individual access to investment information, reference and research libraries and providing information inputs for ongoing financial, legal, investment and other support and functions. Currently, these activities are disjoint and provided independently of each other. In addition, many vital services and activities as well as important investment and/or reference information are not provided in an automated way. Client/advisor history is typically kept in off line data storage and is cumbersome to review and disseminate. Further, the client/advisor interaction suffers lost productivity and opportunity due to delays in communication and coordination between the parties (particularly in cases where many advisors are to be included on the client's support team). With the advent of multiple discipline practices in the advisor and other communities, many of these issues may become exacerbated due to lack of consistency and standardization.

Historically, clients and advisors had to communicate via telephone, mail, e-mail, facsimile, in person meetings, and/or conference calls, for example. Various problems and difficulties often result from such communication methods when dealing with a team of advisors or other participants. For example, advisors and clients may have difficulty in scheduling times and places for face to face meetings or conference calls. Also, delays may result due to sending documents to all of the team members who may need to review the documents. In addition, incomplete decision making often result due to information or documents not being available to all parties involved. Other problems include wasted time and costs involved in sending documents as well as difficulty of coordinating document revisions or other actions. Such problems and difficulties cause delays in completing the transactions, higher overhead costs, lost financial opportunities, and frustration.

Although some conventional collaboration systems provide automated solutions for scheduling and communication between advisors and clients, these existing systems do not allow the advisor to proactively manage client interactions and configure client interaction metrics or checkpoints. Conventional systems also do not allow configuration and usage of client-specific communication templates providing customized client communication based on an appropriate client role, tone, and portfolio status. Finally, conventional systems do not provide easy-to-use information displays and user interfaces that enable an advisor to quickly ascertain the current status of the advisor's interactions with clients.

### BRIEF DESCRIPTION OF THE DRAWINGS

The various embodiments are illustrated by way of example, and not by way of limitation, in the figures of the accompanying drawings in which:

FIG. 1 illustrates an example embodiment of a client interaction management system in a network-enabled ecosystem;

FIG. 2 illustrates a home page of a user interface presented to a user when the client interaction management system of an example embodiment is initially launched;

FIGS. 3 through 6 illustrate sample pages of a user interface presented to a user by the client interaction management system of an example embodiment when the Quick Connect function of the example embodiment is activated;

FIGS. 7 through 18 illustrate sample pages of a user interface presented to a user by the client interaction management system of an example embodiment when the Matrix function of the example embodiment is activated;

FIGS. 19 through 25 illustrate sample pages of a user interface presented to a user by the client interaction management system of an example embodiment when the Differentiate function of the example embodiment is activated;

FIG. 26 illustrates a sample page of a user interface presented to a user by the client interaction management system of an example embodiment when the Capture function of the example embodiment is activated;

FIG. 27 is a processing flow chart illustrating an example embodiment of a method as described herein;

FIG. 28 illustrates another example embodiment of a networked system in which various embodiments may operate; and

FIG. 29 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for business process automation for financial advisors are disclosed. The various embodiments enable an advisor to proactively manage client interactions and to configure client interaction metrics or checkpoints. The various embodiments further enable configuration and usage of client-specific communication templates providing customized client communication content based on a user-selected sender role, a user-selected message tone, and portfolio status. Additionally, the various embodiments provide easy-to-use information displays and user interfaces that enable an advisor to quickly ascertain the current status of the advisor's interactions with clients.

In various embodiments described in detail below, a software application program is used to gather, process, and distribute advisor and client information, including financial data, using a computer system, a web appliance, and/or a mobile device. As described in more detail below, the computer or computing system on which the described embodiments can be implemented can include personal computers (PCs), portable computing devices, laptops, tablet computers, personal digital assistants (PDAs), wearable computing devices, personal communication devices (e.g., cellular telephones, smartphones, or other wireless devices), network computers, set-top boxes, consumer electronic devices, or any other type of computing, data processing, communication, networking, or electronic system.

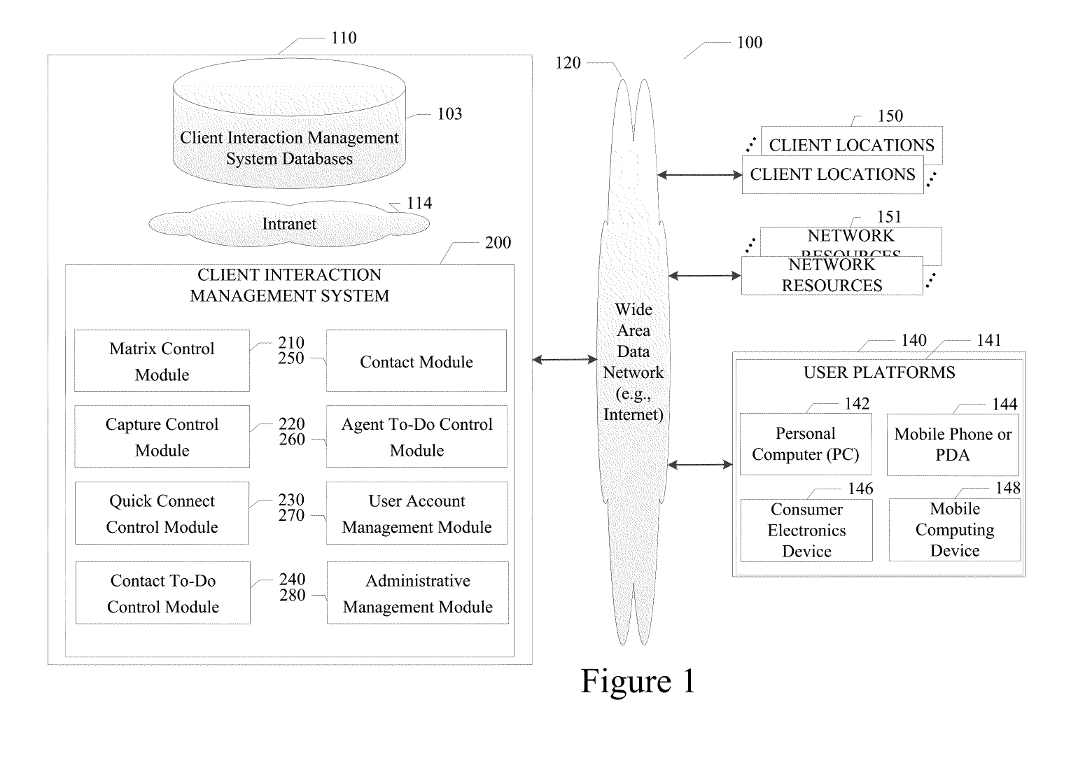

Referring now to FIG. 1, in an example embodiment, a system for client interaction management 100 in a network-enabled ecosystem is disclosed. In various example embodiments, an application or service, typically provided by or operating on a host site (e.g., a website) 110, is provided to simplify and facilitate the downloading or hosted use of the client interaction management system 200 of an example embodiment. In a particular embodiment, the client interaction management system 200, or a portion thereof, can be downloaded from the host site 110 by a user at a user platform 140. Alternatively, the client interaction management system 200 can be hosted by the host site 110 for a networked user at a user platform 140. The details of the client interaction management system 200 of an example embodiment are provided below.

Referring again to FIG. 1, the client interaction management system 200 can be in network communication with a plurality of user platforms 140. The host site 110 and user platforms 140 may communicate and transfer data and information in the data network ecosystem 100 shown in FIG. 1 via a wide area data network (e.g., the Internet) 120. Various components of the host site 110 can also communicate internally via a conventional intranet or local area network (LAN) 114.

In an example embodiment, the client interaction management system 200 can also be in network communication with a plurality of client locations 150 and a plurality of network resources 151. Client locations 150 can represent the network locations of clients or client computing systems being managed by an advisor or an advisor business using an embodiment described herein. Network resources 151 can represent the network locations of agent team members, third party contacts, affiliates, information sources, or other contacts or network resources that may provide or consume data associated with the client interaction management system 200 of the example embodiment.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through an Ethernet port or a universal serial bus (USB) port, other forms of computer-readable media, or any combination thereof. On an interconnected set of LANs, including those based on differing architectures and protocols, a router and/or gateway device can act as a link between LANs, enabling messages to be sent between computing devices. Also, communication links within LANs may include optical fiber data lines, twisted wire pairs or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), optical fiber, wireless links including satellite links, or other communication links known to those of ordinary skill in the art. Furthermore, remote computers and other related electronic devices can be remotely connected to either LANs or WANs via a wireless link, WiFi, Bluetooth, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to be moved freely and randomly and to organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The client interaction management system can be implemented using any form of network transportable digital data. The network transportable digital data can be transported in any of a group of data packet or file formats, protocols, and associated mechanisms usable to enable a host site 110 and a user platform 140 to transfer data over a network 120. In one embodiment, the data format for the user interface can be HyperText Markup Language (HTML). HTML is a common markup language for creating web pages and other information that can be displayed in a web browser. In another embodiment, the data format for the user interface can be Extensible Markup Language (XML). XML is a markup language that defines a set of rules for encoding interfaces or documents in a format that is both human-readable and machine-readable. In another embodiment, a JSON (JavaScript Object Notation) format can be used to stream the interface content to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML. The Hypertext Transfer Protocol (HTTP) or secure HTTP (HTTPS) can be used as a network data communication protocol.

In a particular embodiment, a user platform 140 with one or more client devices 141 enables a user to access data and provide data and/or instructions for the client interaction management system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive content data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., Twitter), Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

As one option, the client interaction management system 200, or a portion thereof, can be downloaded to a user device 141 of user platform 140 and executed locally on a user device 141. The downloading of the client interaction management system 200 application (or a portion thereof) can be accomplished using conventional software downloading functionality. As a second option, the client interaction management system 200 can be hosted by the host site 110 and executed remotely, from the user's perspective, on host system 110. In one embodiment, the client interaction management system 200 can be implemented as a service in a service-oriented architecture (SOA) or in a Software-as-a-Service (SAAS) architecture. In any case, the functionality performed by the client interaction management system 200 is as described herein, whether the application is executed locally or remotely, relative to the user.

Referring again to FIG. 1, the host site 110 and client interaction management system 200 of an example embodiment is shown to include a client interaction management system database 103. The database 103 is used in an example embodiment for data storage of information related to client records, portfolio data, client templates, client and agent roles, calendar data, configuration data, scheduling data, reporting data, and the like. It will be apparent to those of ordinary skill in the art that the database 103 can represent multiple datasets and can be used for the storage of a variety of data in support of the client interaction management system 200 of an example embodiment. In a particular embodiment, the type of database used is a Filemaker Pro® database produced by FileMaker® Inc., formerly Claris®, a subsidiary of Apple® Inc.

Referring again to FIG. 1, host site 110 of an example embodiment is shown to include the client interaction management system 200. Client interaction management system 200 can include a Matrix Control Module 210, a Capture Control Module 220, a Quick Connect Control Module 230, a Contact To-Do Control Module 240, a Contact Module 250, an Agent To-Do Control Module 260, a User Account Management module 270, and an Administrative Management module 280. Each of these modules can be implemented as software components executing within an executable environment of client interaction management system 200 operating wholly or in part on host site 110 or user platform 140. Each of these modules of an example embodiment is described in more detail below in connection with the figures provided herein.

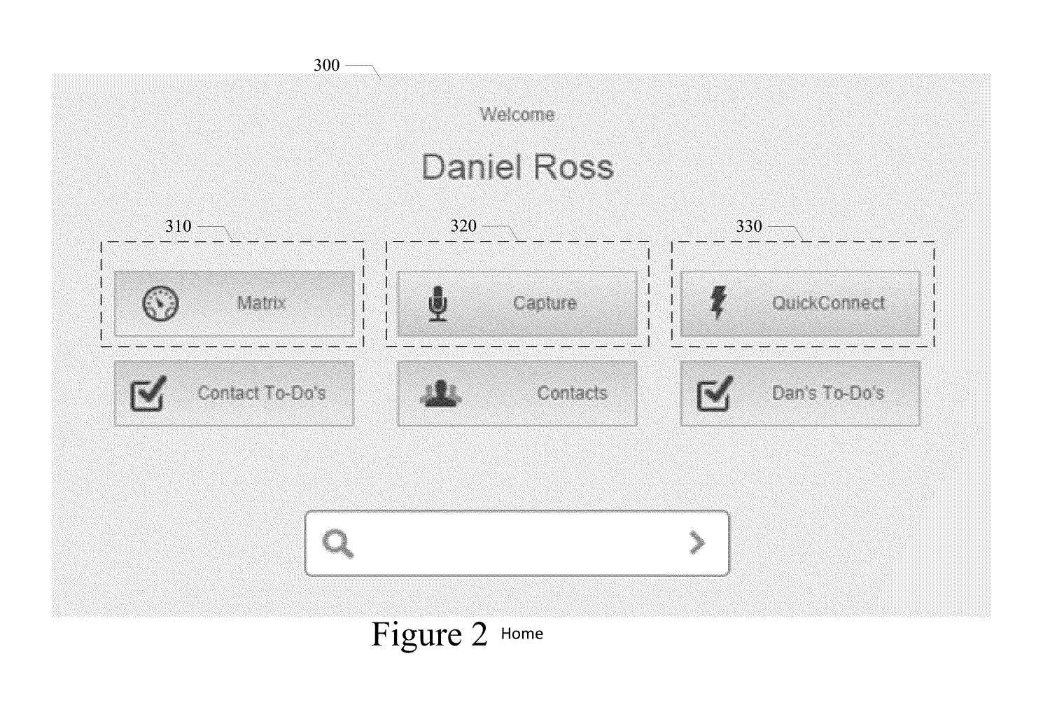

FIG. 2 illustrates a home page of a user interface presented to a user when the client interaction management system 200 of an example embodiment is initially launched. As described above, the client interaction management system 200 can be configured to operate wholly or in part on host site 110 or a user platform 140. Software components executing within an executable environment of client interaction management system 200 can present various pages of a user interface to a user at a user platform 140. These pages can be presented using well-known protocols and data transfer interfaces. The home page 300 shown in FIG. 2 is presented when an example embodiment of the client interaction management system 200 is initially activated or launched. As shown, the example embodiment presents a set of command or function options as softkeys, input objects, or other user interface mechanisms, which enable a user to signal activation of a desired option. As well-known to those of ordinary skill in the art, such user interface mechanisms can be implemented using touchscreens, physical buttons, regions on a display screen that can be selected using a pointing device, alphanumeric codes or keystrokes, or the like. In the example embodiment, these command or function options can include, among others, the Matrix function 310, the Capture function 320, and the Quick Connect function 330. In response to the activation of the Matrix function 310 by the user, the Matrix Control Module 210 of client interaction management system 200 shown in FIG. 1 takes control to process the user input and output related to the Matrix function of the example embodiment. In response to the activation of the Capture function 320 by the user, the Capture Control Module 220 of client interaction management system 200 shown in FIG. 1 takes control to process the user input and output related to the Capture function of the example embodiment. In response to the activation of the Quick Connect function 330 by the user, the Quick Connect Control Module 230 of client interaction management system 200 shown in FIG. 1 takes control to process the user input and output related to the Quick Connect function of the example embodiment. Each of these functions of an example embodiment are described in more detail below.

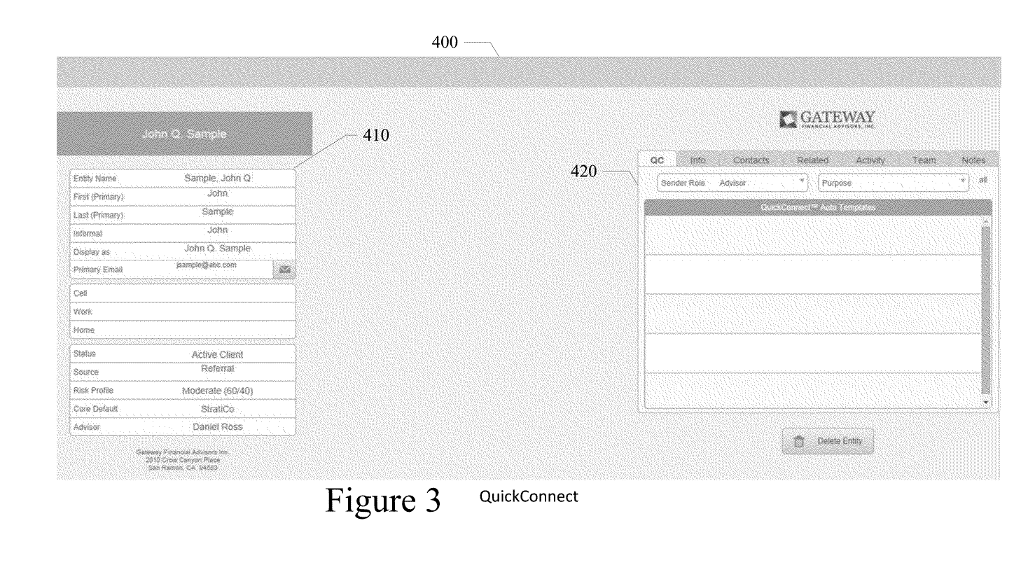

FIGS. 3 through 6 illustrate sample pages of a user interface presented to a user by the client interaction management system 200 of an example embodiment when the Quick Connect function 330 of the example embodiment is activated. In the example embodiment, the Quick Connect function 330 is generally used to enable an agent to streamline communication and interaction with relationship contacts. Streamlined scheduling provides automated scheduling via an integrated online calendar. Activity and schedule monitoring assures timely and relevant interactions and communications with clients. The example embodiment provides roles-based logic and live synchronization to keep all agent team members informed of the client's interaction and status. Additionally, because the various embodiments can be used with mobile user platforms 141, mobile functionality provides an intuitive system that optimizes efficiency for mobile users. The user interface provided by various embodiments described herein enables a consistent user experience regardless of the type of client interaction or the type of interaction platform used.

The Quick Connect function 330 of the example embodiment provides communication and interaction management tools to enable the client interaction management system 200, and a user thereof, to create and monitor client activities and action items. Additionally, the client interaction management system 200, and the user thereof, can monitor market metrics and alert contacts when pre-defined key market signals or triggers are activated. The example embodiment also provides seasonal planning and special date and holiday tracking to customize a client interaction based on a calendar date or time of year. The example embodiment also provides alerts related to portfolio and strategic rebalancing. Finally, the example embodiment enables simultaneous notification to relationship contacts of press releases and public announcements.

Referring now to FIG. 3, a first sample page 400 illustrates the user interface presented to the user when the Quick Connect function 330 of the example embodiment is activated. As shown, page 400 includes a contact information block 410 and a Quick Connect function block 420. In the example embodiment, a contact list or address book can be maintained for storage of contact information specific to a plurality of contacts. The contacts can be clients, agents, agent team members, affiliates, or other related parties. The contact information can include the contact name, address, phone numbers, email addresses, status, source, risk profile, and affiliated agent. This contact information can be displayed and edited using the contact information block 410.

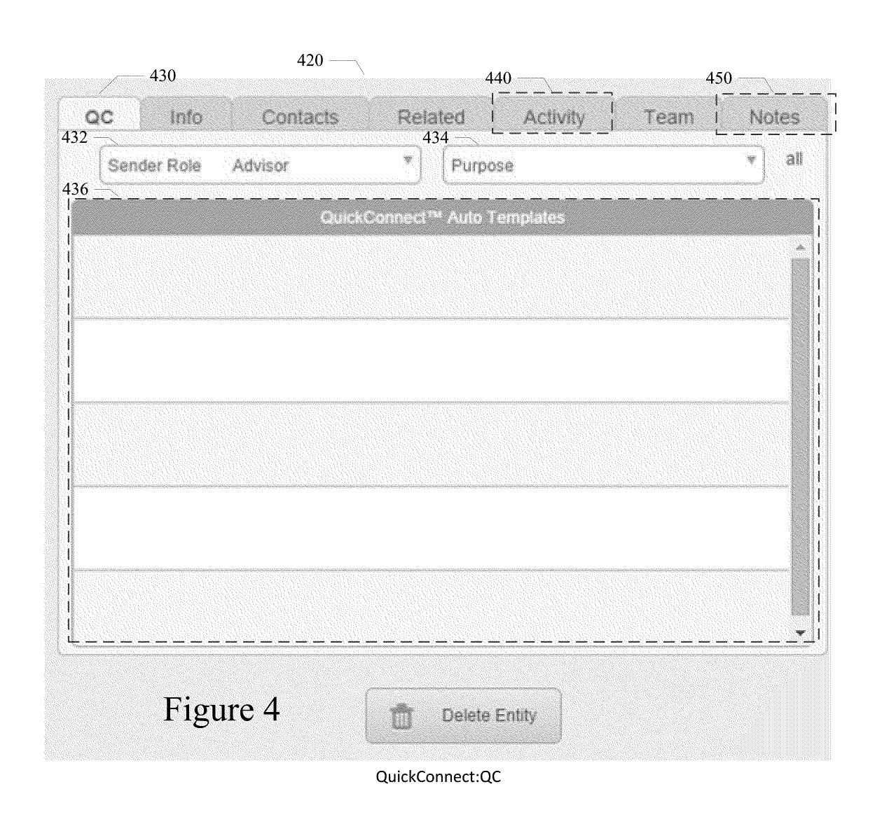

Referring now to FIG. 4, a detail view of the Quick Connect function block 420 is illustrated. As described above, a particular agent can populate the contact list with, among other contacts, a plurality of clients with whom the agent wishes to manage interactions. In an embodiment wherein the agent is a financial advisor, the clients can be investors who each own a portfolio of investments being managed by the agent. As well known, the status and value of the plurality of client investment portfolios can change rapidly as events occur in the market. In this case, it is important for the agent to regularly communicate with each client to make sure the client is aware of market events and to verify that the clients' investment goals have not changed since a prior agent/client interaction. In the absence of a client interaction management system as disclosed herein, the agent would be continually immersed in the details of remembering prior conversations with clients, drafting unique communications for particular clients, and scheduling subsequent client interactions.

As provided in the Quick Connect function block 420 shown in FIG. 4, the example embodiment enables the agent to initiate communications or other interactions with a particular client using one of a plurality of communication templates provided in template block 436. Each communication template in template block 436 can represent particular pre-defined message content for a particular individual client, a particular client group, a particular client category, or multiple clients, groups, or categories. The client groups and client categories can be pre-defined in a different user interface provided by the client interaction management system 200. The particular pre-defined message content can be associated with common communications that occur between the agent and the client over the course of the management of the client's investment portfolio or other client representation. The particular pre-defined message content of each template can also be automatically modified based on a user-selectable role of the sender or a user-selectable tone for the message content. The role of the sender can be selected using input object 432. In a particular embodiment, the plurality of selectable sender roles can include: director, advisor, service provider, business development, or social. The tone of the message content can be selected using input object 434. The tone of the message content can be associated with the purpose of the message as selected from a plurality of options, including: appointment, contact, goals, needs, strategy, and optimization. As a result of the selection of a particular role and tone, the content of the message can be automatically tailored for a specific client (or client group or category) and a specific situation. Thus, the agent can spend less time generating unique communications for each client.

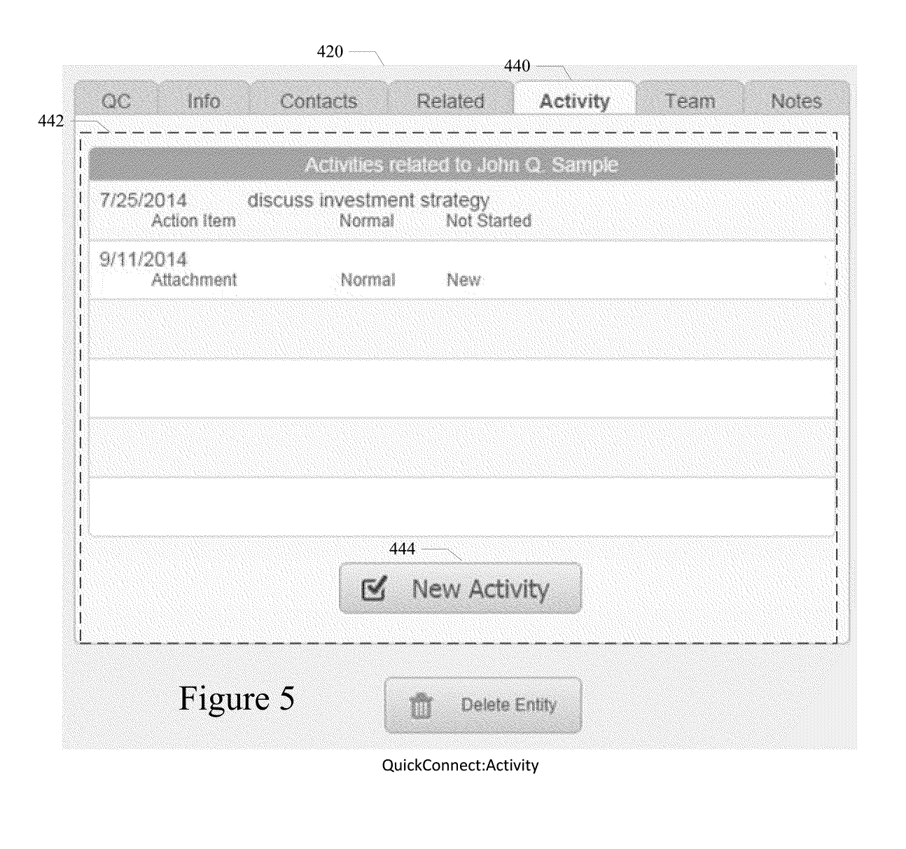

As provided in the Quick Connect function block 420 shown in FIG. 4, the example embodiment enables the agent to assign activities to each client. Using tab 440 of a tab bar provided as part of the Quick Connect function block 420 as shown in FIG. 5, the agent can view a set of previously created activities for the client in a client activity block 442. Each entry in the client activity block 442 represents an action the agent may take or a reminder the agent may record in the representation of the particular client. For example, the agent may create a client activity to trigger a communication with the client regarding a particular action or event related to the client's investment portfolio. Each client activity can be dated and appropriately described. Each client activity can also be prioritized with a user or system assigned priority and associated with a current status. The client interaction management system 200 can record the client activities and can monitor the associated dates. The client interaction management system 200 can also automatically issue alerts or messages to the agent or otherwise notify the agent when client activities become due based on the associated date, priority, or status. The agent can also attach links to particular client activities. The links can connect a particular client activity to associated documents, emails, webpages, contacts, calendar events, and the like. A user input object 444 is provided to enable the agent to create a new activity for the particular client or any other contact in the contact list.

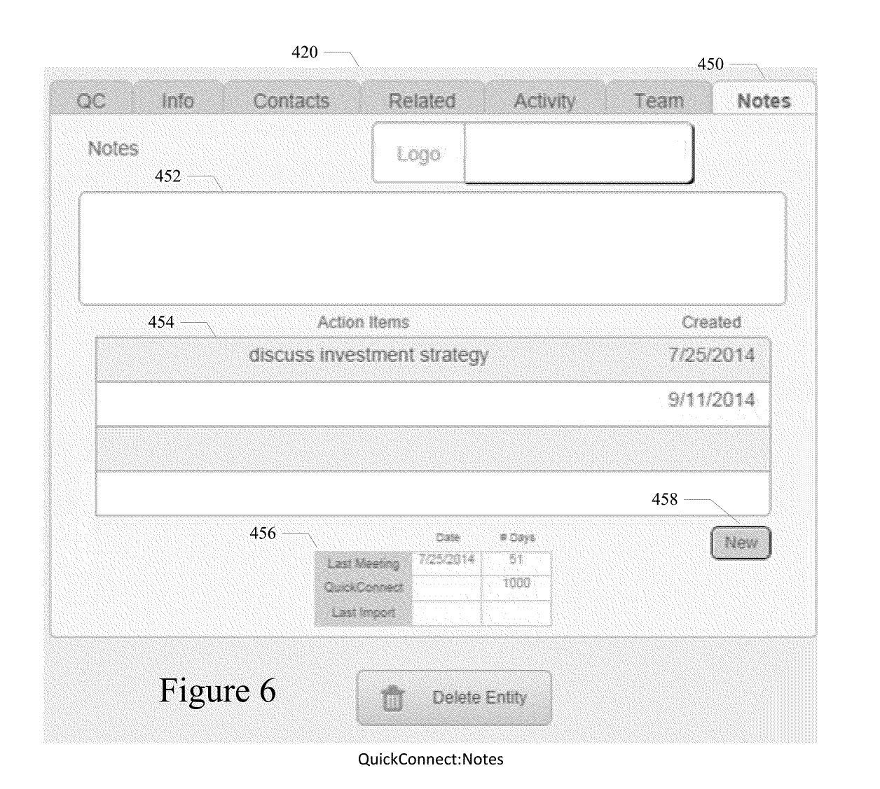

Referring again to FIG. 4, as provided in the Quick Connect function block 420 shown in FIG. 4, the example embodiment enables the agent to record notes for each client. Using tab 450 of a tab bar provided as part of the Quick Connect function block 420 as shown in FIG. 6, the agent can view a set of previously created notes for the client in a client note block 452. Additionally, the agent can view the activities or action items associated with the particular client in action item block 454. The associated activity dates and descriptions are also displayed in action item block 454. A user input object 458 is provided to enable the agent to create a new activity or action item for the particular client or any other contact in the contact list. Note information block 456 is also presented to inform the agent regarding the dates associated with the previous and subsequent interactions with the client. The client activity and note features of the example embodiment enable the agent to quickly review the interactions needed (or previously conducted) for particular clients and to define subsequent interactions for particular clients, client groups, or client categories.

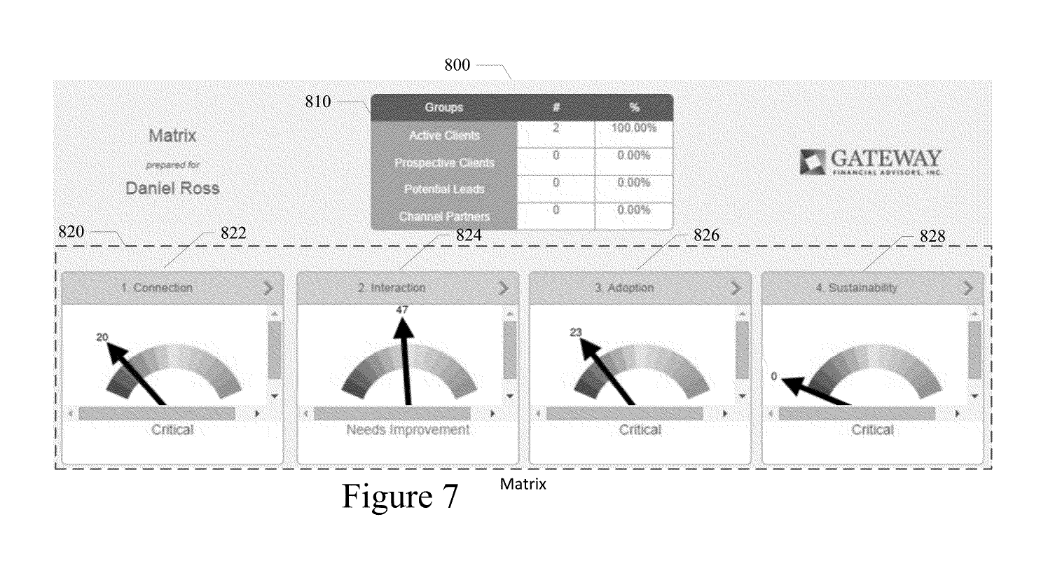

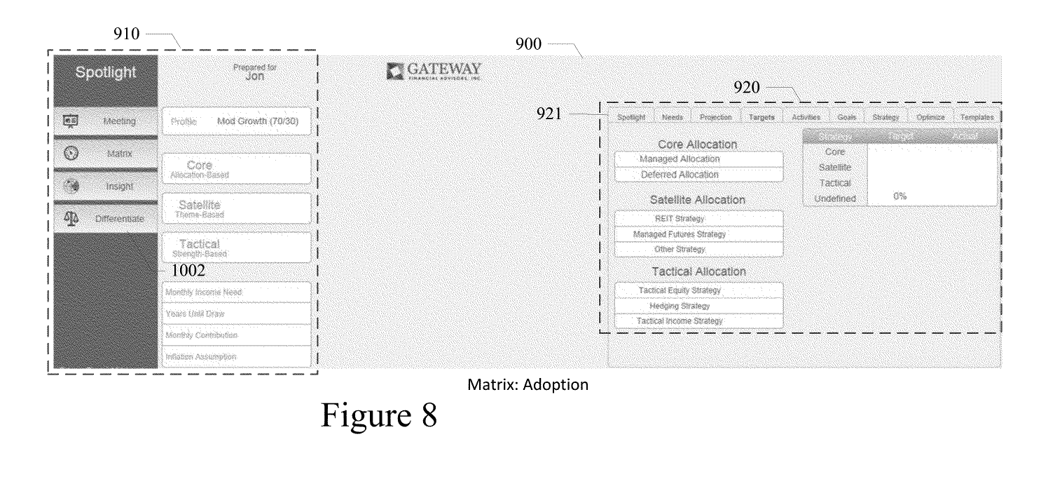

FIGS. 7 through 18 illustrate sample pages of a user interface presented to a user by the client interaction management system 200 of an example embodiment when the Matrix function 310 of the example embodiment is activated. In the example embodiment, the Matrix function 310 is generally used to enable an agent to view an aggregation of key client performance metrics at a quick glance. As shown in FIG. 7, the Matrix function 310 generates a set of performance gauges 820 or other graphic images summarized in four different dimensions to inform the agent of the current level of performance of the aggregate of the agent's clients in each of four different dimensions, including: connection 822, interaction 824, adoption 826, and sustainability 828. Each of the performance gauges 820 can be selected and activated by the user (e.g., by use of a pointing device) to obtain more detailed information for the selected dimension. The connection dimension 822 provides a set of metrics that measure the degree to which the agent has set up connections with clients. The interaction dimension 824 provides a set of metrics that measure the degree to which the agent is actively interacting and engaged with clients. In particular, the interaction dimension 824 can summarize or measure the agent's responsiveness to a plurality of activities associated with the plurality of the agent's clients. As described above, the features of the Quick Connect function 330 of the example embodiment can be used to capture and maintain metrics for the connection dimension 822 and the interaction dimension 824 for each of the clients. For example, the Quick Connect function 330 can be used to determine if the agent has regularly set up and conducted the appropriate level of activities for each of the agent's clients. The adoption dimension 826 provides a set of metrics that measure the degree to which the agent's aggregated clients have adopted the strategies and actions proposed by the agent. The sustainability dimension 828 provides a set of metrics that measure the degree to which the agent's aggregated clients are on track to meet their goals. The adoption dimension 826 and the sustainability dimension 828 are described in more detail below in reference to FIGS. 8 through 18.

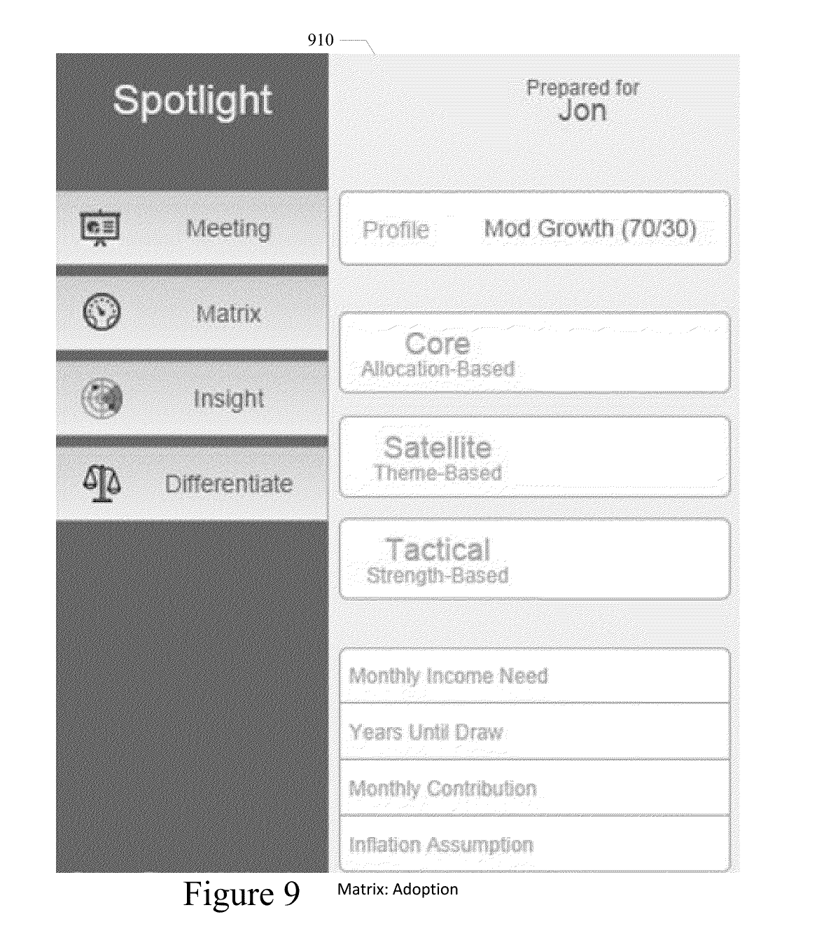

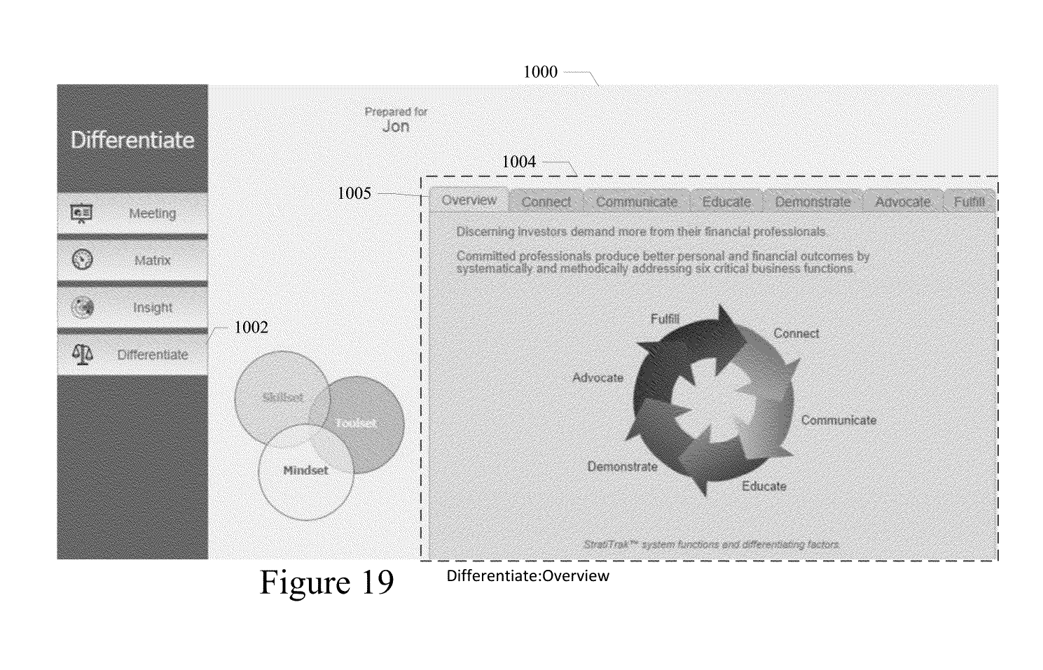

Referring now to FIG. 8, a first sample page 900 illustrates the user interface presented to the user when the adoption gauge 826 shown in FIG. 7 is selected or activated. As shown, page 900 includes a contact spotlight block 910 and an asset allocation block 920. In the example embodiment as shown in FIG. 9, the spotlight block 910 presents a summary of the investment parameters associated with a particular client. For example, the spotlight block 910 displays the client's current investment strategy profile, asset allocation summary, income needs, the number of years until draws are needed, the client's monthly contribution level, and the inflation assumption. Additionally, the contact spotlight block 910 provides user input objects to enable the agent or client to schedule a meeting (Meeting), to enable the agent or client to obtain market or reference information (Insight), or to enable the agent or client to obtain information pertaining to ways that the client interaction management system of an example embodiment is different from existing systems (Differentiate). The Differentiate option functionality is described in more detail below in connection with FIGS. 19 through 25.

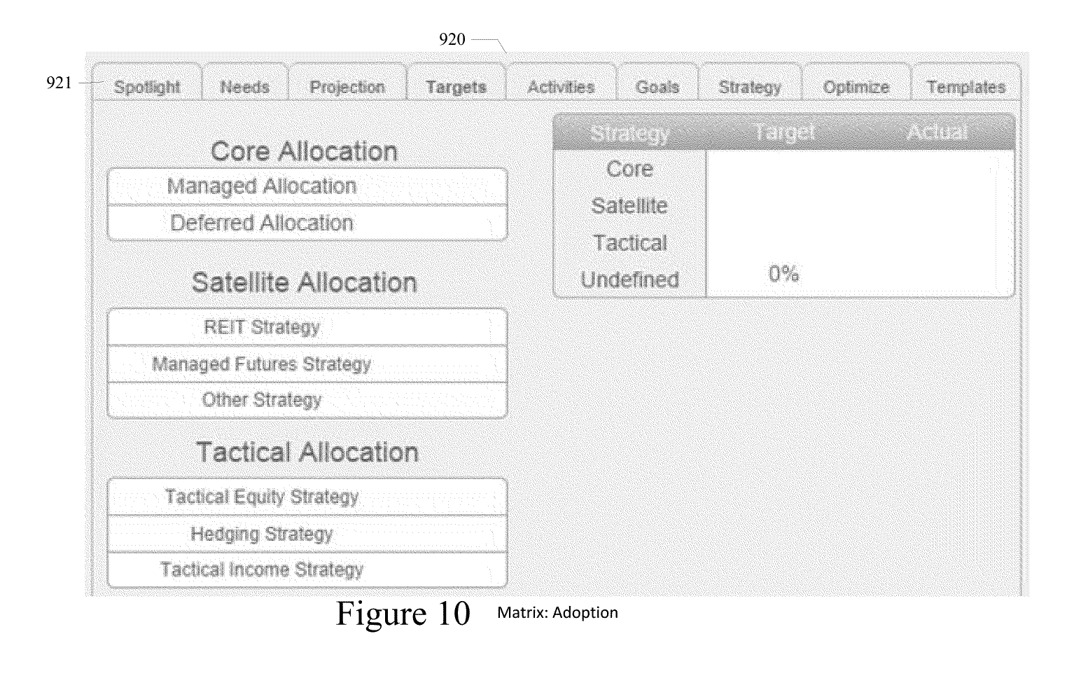

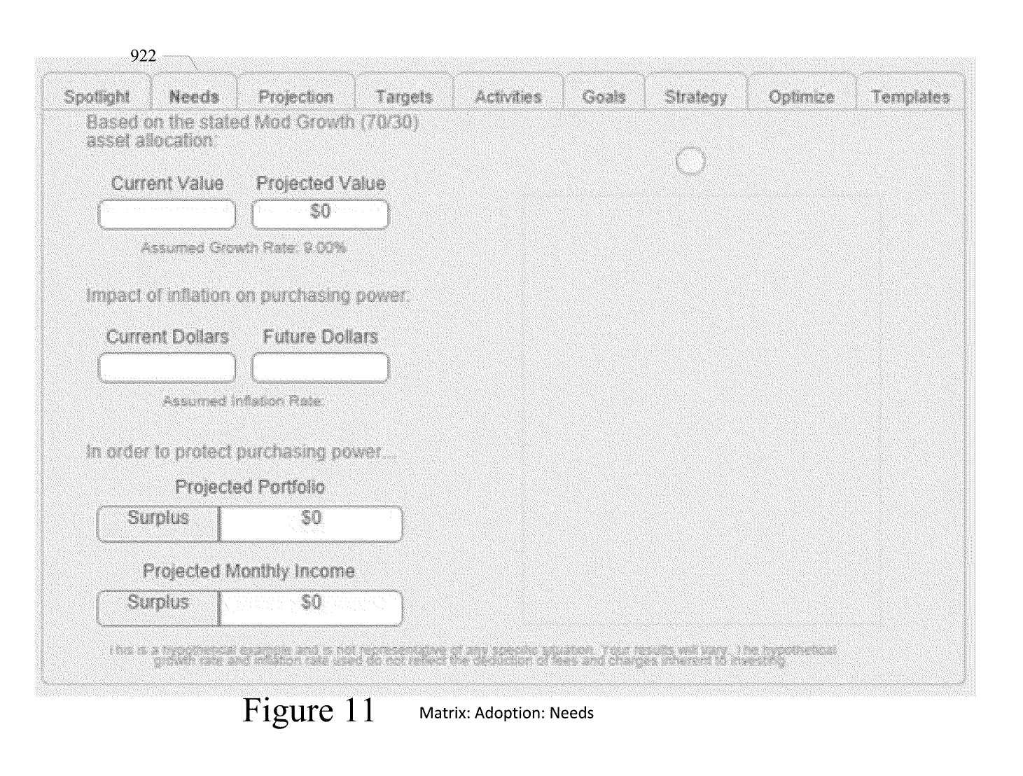

Referring again to FIG. 8, the first sample page 900 includes asset allocation block 920. The asset allocation block 920, as shown in detail in FIG. 10, provides a detailed view of a particular client's current asset allocation in their investment portfolio. The asset allocation block 920 also provides a set of tools in a tab bar 921 for managing a variety of issues related to a particular client and the client's portfolio. The details of each of the tabs in tab bar 921 are described in more detail below in connection with FIGS. 11 through 18.

Referring now to FIG. 11, a sample page illustrates the user interface presented to the user when the Needs tab 922 of tab bar 921 shown in FIG. 10 is selected or activated. The Needs tab 922 enables the user to manage the level of capital or income needed by the particular client. As such, the user interface allows the user to specify the current and projected value of the client's portfolio and the value adjusted for inflation. The portfolio values are based on the asset allocation strategy selected by or for the client (e.g., conservative or growth strategies, etc.). The user interface also shows the client's projected purchasing power based on the value of the portfolio.

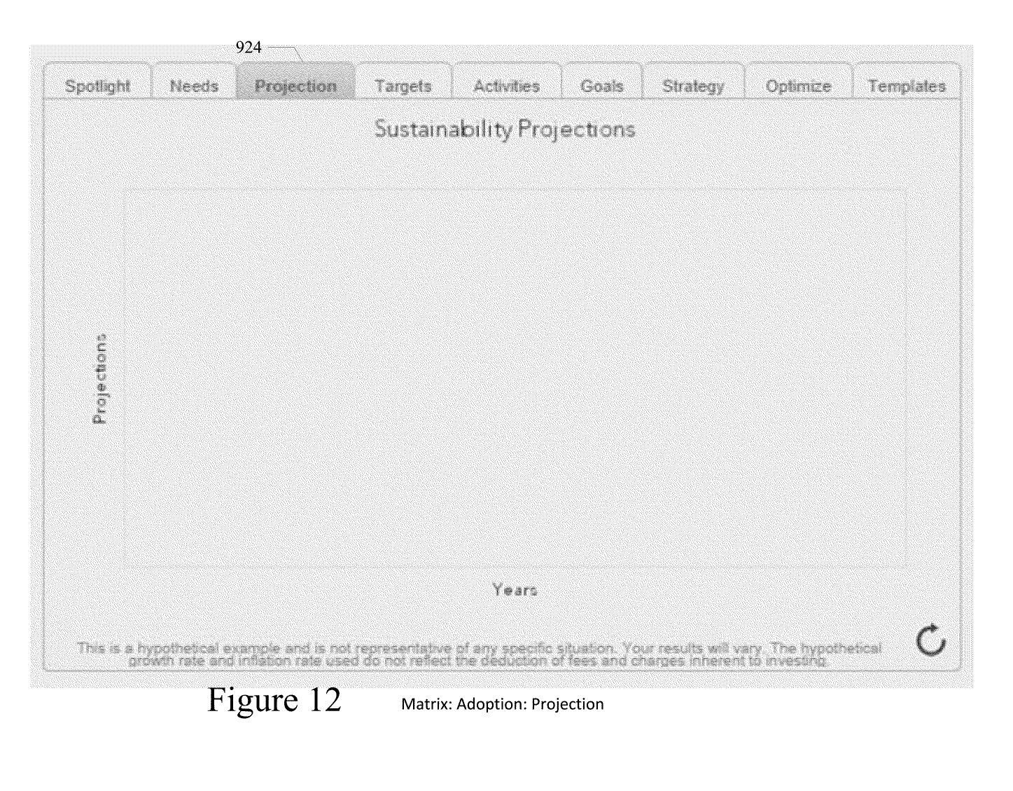

Referring now to FIG. 12, a sample page illustrates the user interface presented to the user when the Projection tab 924 of tab bar 921 shown in FIG. 10 is selected or activated. The Projection tab 924 enables the user to manage the sustainability of the client's portfolio over time. The user interface in an example embodiment displays a graph of the client portfolio sustainability projections over a number of years.

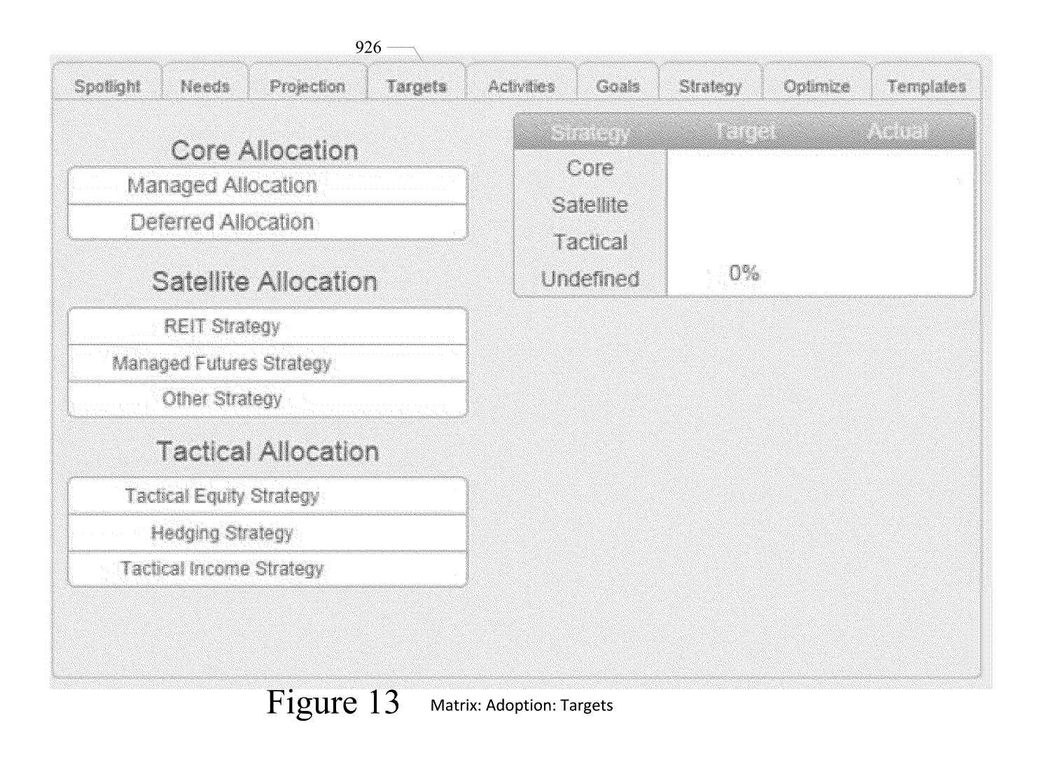

Referring now to FIG. 13, a sample page illustrates the user interface presented to the user when the Targets tab 926 of tab bar 921 shown in FIG. 10 is selected or activated. The Targets tab 926 enables the user to set financial targets for an investment portfolio. In a particular embodiment, a portfolio can be partitioned into separate portions denoted the core allocation, the satellite allocation, and the tactical allocation. The various portfolio partitions can have independently specified targets based on a selected investment strategy. The user interface also shows the actual performance of the portfolio partitions in comparison to the specified targets.

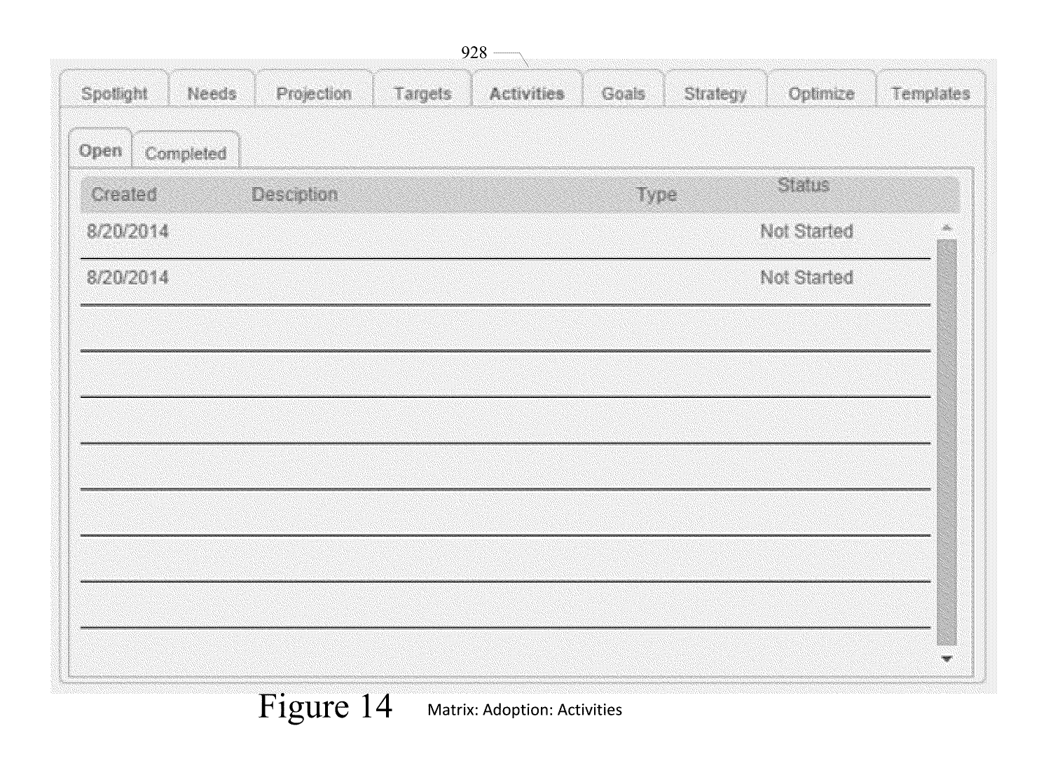

Referring now to FIG. 14, a sample page illustrates the user interface presented to the user when the Activities tab 928 of tab bar 921 shown in FIG. 10 is selected or activated. The Activities tab 928 enables the user to manage the various activities associated with a particular agent's clients. The lists of open or completed activities can be viewed or modified from the activities page of the Matrix function 310.

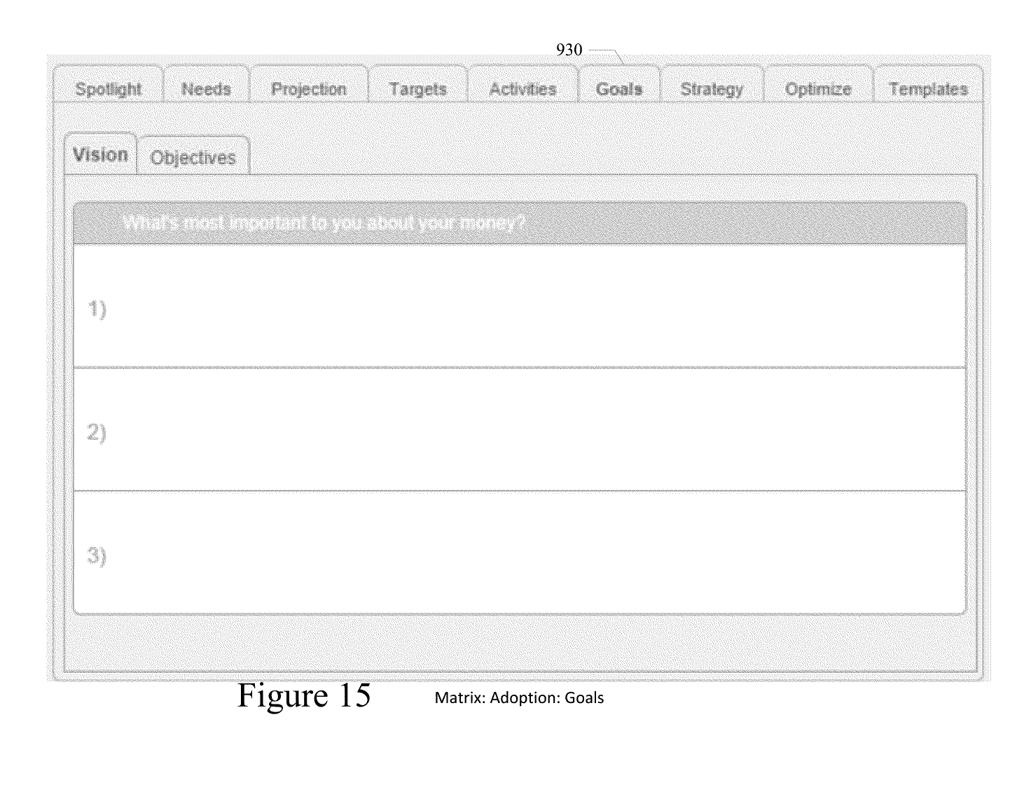

Referring now to FIG. 15, a sample page illustrates the user interface presented to the user when the Goals tab 930 of tab bar 921 shown in FIG. 10 is selected or activated. The Goals tab 930 enables the user to view, create, or modify a set of goals, visions, or objectives associated with one or more clients. The Goals page allows an agent to capture a set of objectives the client seeks to accomplish with the client's investment portfolio. The list of goals can be used by the agent to develop a strategy to accomplish the goals.

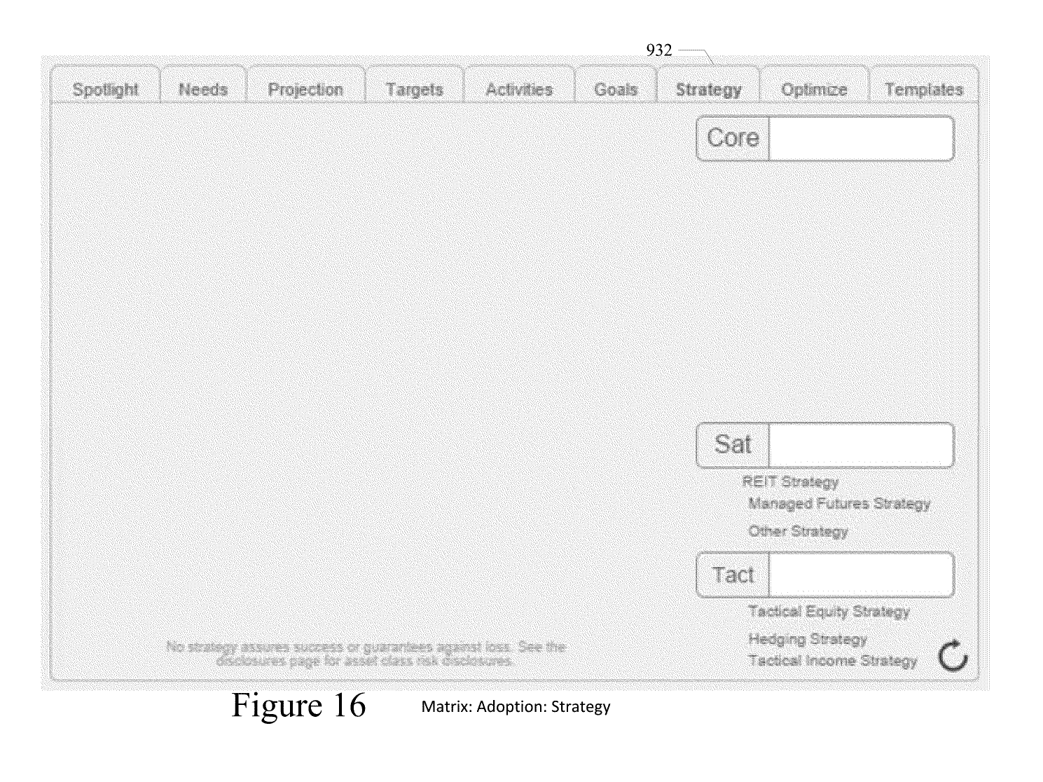

Referring now to FIG. 16, a sample page illustrates the user interface presented to the user when the Strategy tab 932 of tab bar 921 shown in FIG. 10 is selected or activated. The Strategy tab 932 enables the user to manage the strategy or investment plan that will be proposed or used to achieve the client's stated goals. The strategy can be developed separately for the core portion of the client's portfolio, the satellite portion of the portfolio, and the tactical portion of the portfolio.

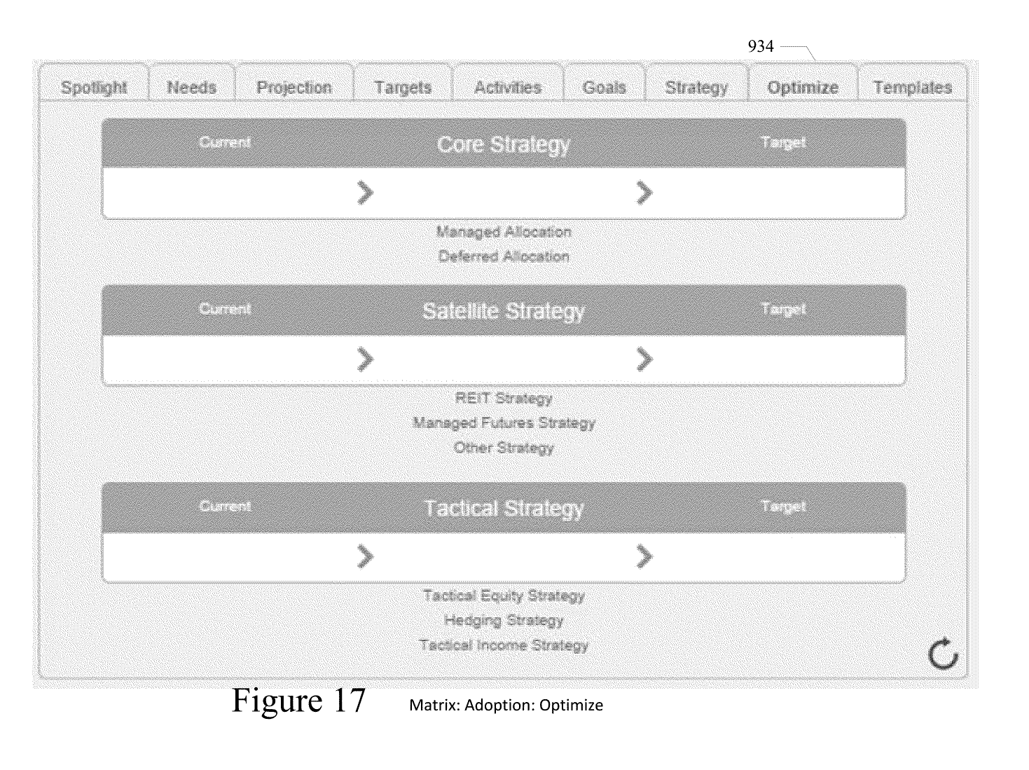

Referring now to FIG. 17, a sample page illustrates the user interface presented to the user when the Optimize tab 934 of tab bar 921 shown in FIG. 10 is selected or activated. The Optimize tab 934 enables the user to compare the client strategies with the client goals to determine if the strategies being employed are effectively accomplishing the goals. Again, this comparison can be developed separately for the core portion of the client's portfolio, the satellite portion of the portfolio, and the tactical portion of the portfolio. The comparisons can map the current performance of the client's portfolio relative to the target performance expected if the client's goals are being met or are on track to being met.

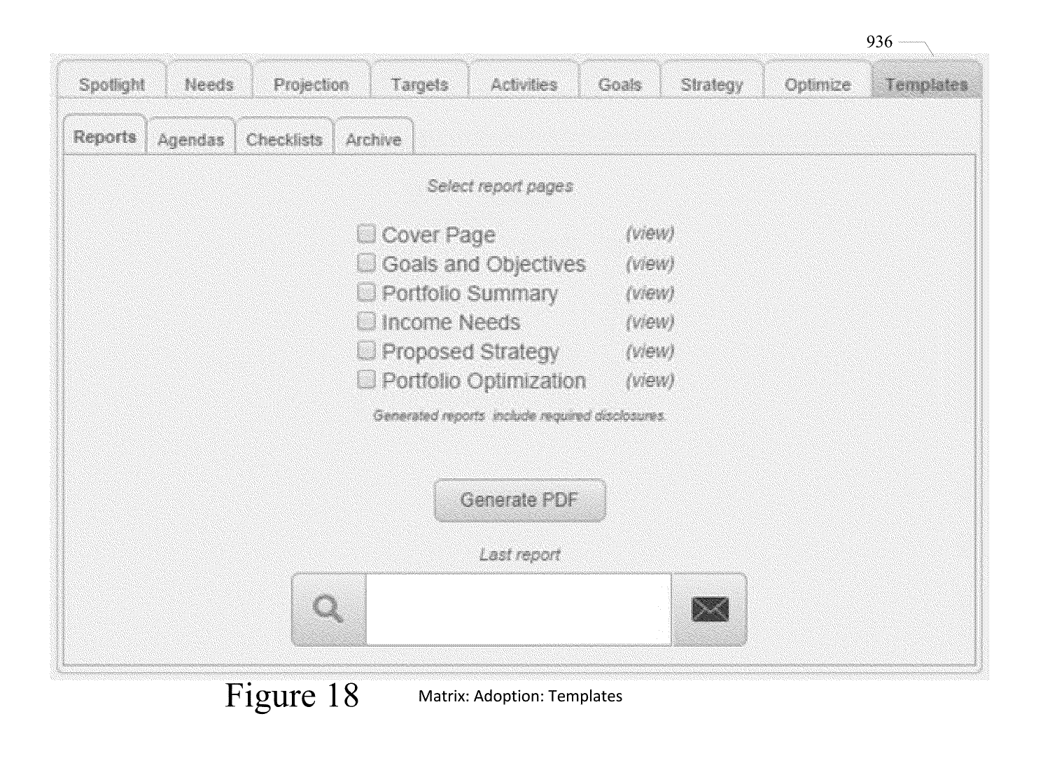

Referring now to FIG. 18, a sample page illustrates the user interface presented to the user when the Templates tab 936 of tab bar 921 shown in FIG. 10 is selected or activated. The Templates tab 936 enables the user to automatically prepare any of a variety of pre-formatted reports or information presentations for the client or other contacts. The Templates page allows the user to select from a list of reports that present various views of the client's information or portfolio information. In the example embodiment, the list of reports can include: a cover page, a goals and objectives report, a portfolio summary report, an income needs report, a proposed strategy report, and a portfolio optimization report. The content of each of these reports can be compiled from the information captured in each of the tab bar 921 pages as described above. Additionally, the user can use the Templates page to view or print agendas or checklists associated with one or more clients or contacts.

Referring again to FIG. 8, the contact spotlight block 910 provides a Differentiate user input object 1002 to enable the agent or client to obtain information pertaining to ways that the client interaction management system 200 of an example embodiment is different from existing systems. FIGS. 19 through 25 illustrate sample pages of a user interface presented to a user by the client interaction management system 200 of an example embodiment when the Differentiate function of the example embodiment is activated via the Differentiate user input object 1002.

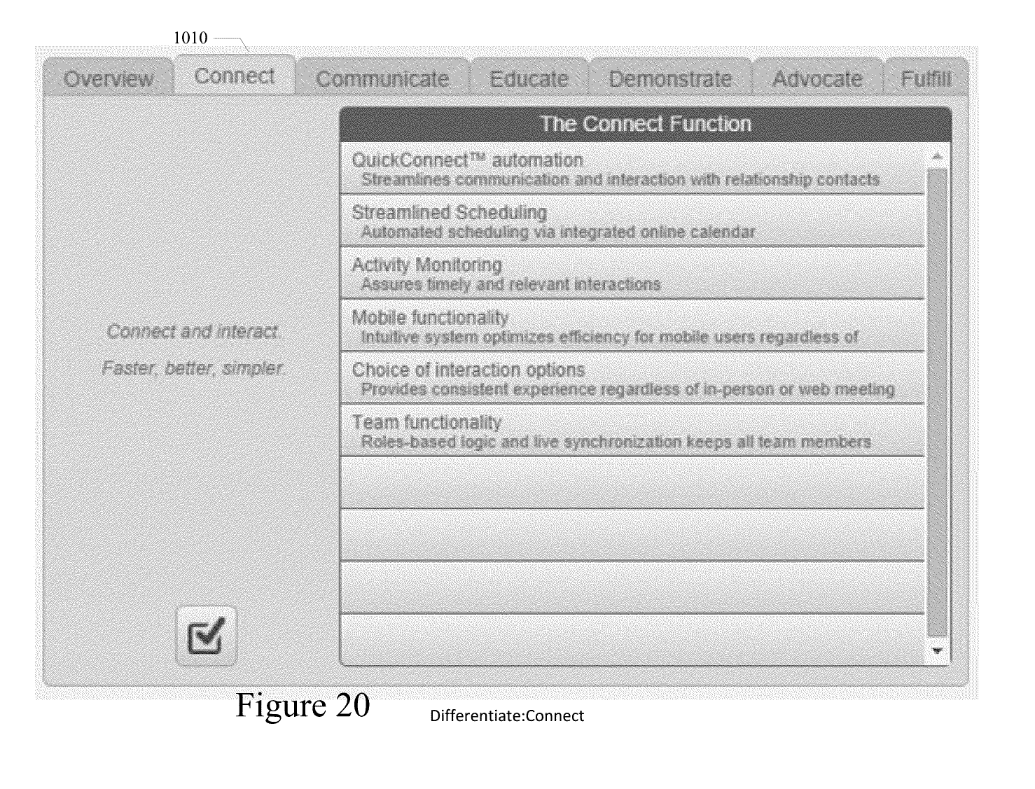

Referring now to FIG. 19, a first sample page 1000 illustrates the user interface presented to the user when the Differentiate function of the example embodiment is activated via the Differentiate user input object 1002. As shown, page 1000 includes a differentiation information block 1004. The differentiation information block 1004 enables the user to view a variety of information pertaining to various ways that the client interaction management system 200 of an example embodiment is different from existing systems. The differentiation information block 1004 includes a graphic showing the six different phases of an effective client interaction in the various embodiments. These phases include: connection, communication, education, demonstration, advocacy, and fulfillment. The differentiation information block 1004 provides a tab bar 1005 to allow the user to select a tab corresponding to any of the six phases of client interaction. Each tab provides a presentation of information related to the selected phase. These phases are described in more detail below in connection with FIGS. 20 through 25.

Referring now to FIG. 20, a sample page illustrates the user interface presented to the user when the Connect tab 1010 of tab bar 1005 shown in FIG. 19 is selected or activated. The Connect tab 1010 informs the user relative to the differences provided by the client interaction management system 200 with respect to client connection. In particular, the connection phase of the example embodiment provides the Quick Connect feature, described above, which streamlines communication and interaction with relationship clients. The connection phase includes streamlined scheduling, which is automated via an integrated online calendar. The connection phase provides activity monitoring for timely and relevant client interactions, intuitive mobile functionality, a choice of interaction options (e.g., in-person, email, phone, web meeting, etc.), and role-based team functionality to provide team support of the client.

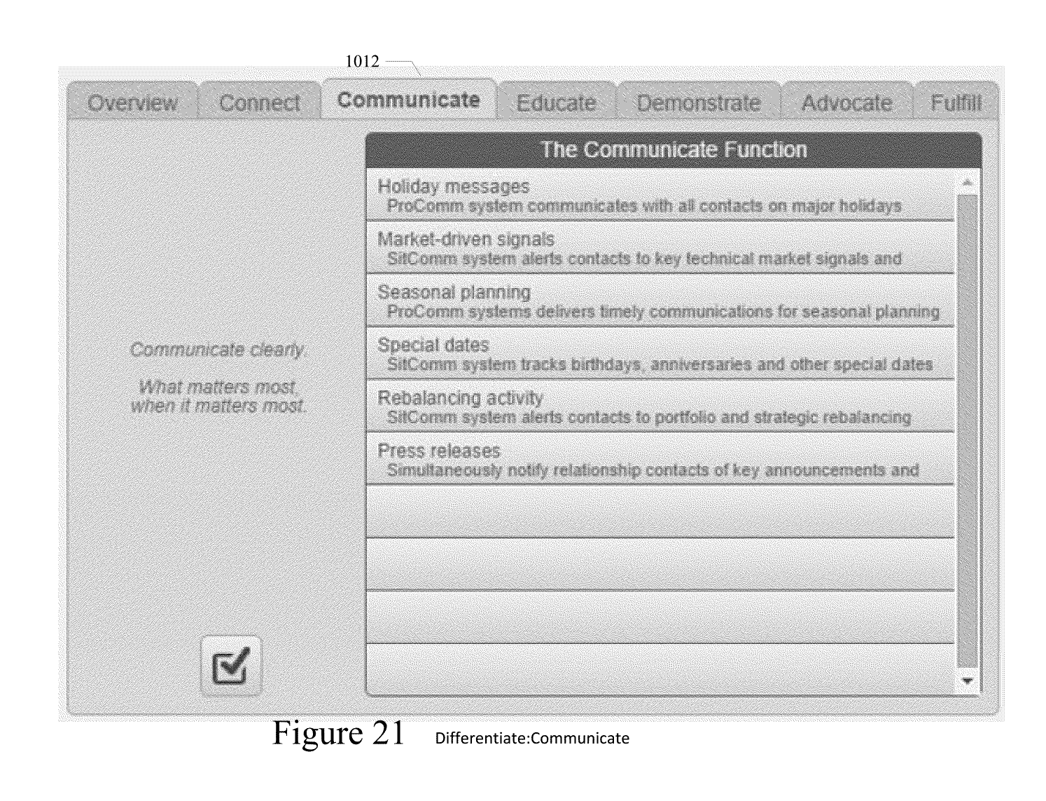

Referring now to FIG. 21, a sample page illustrates the user interface presented to the user when the Communicate tab 1012 of tab bar 1005 shown in FIG. 19 is selected or activated. The Communicate tab 1012 informs the user relative to the differences provided by the client interaction management system 200 with respect to client communication. In particular, the communication phase of the example embodiment provides the Quick Connect feature, described above, which provides seasonal planning and special date and holiday tracking to customize a client interaction based on a calendar date or time of year. The example embodiment also provides alerts related to portfolio and strategic rebalancing. Additionally, the example embodiment enables simultaneous notification to relationship contacts of press releases and public announcements.

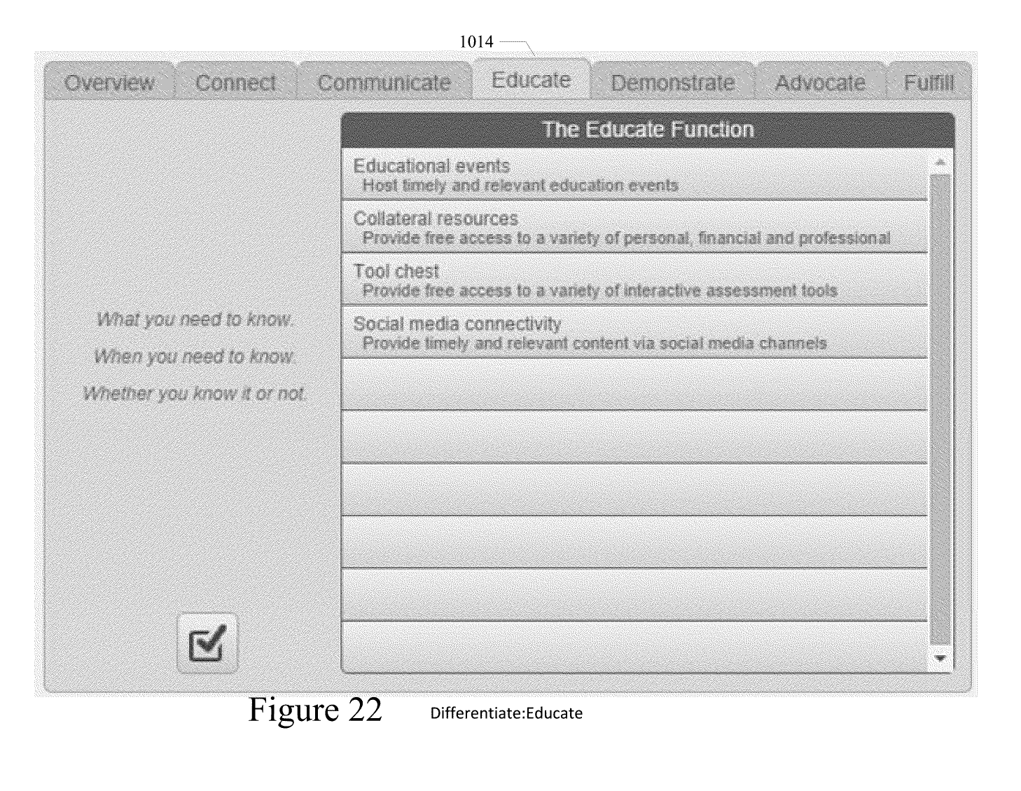

Referring now to FIG. 22, a sample page illustrates the user interface presented to the user when the Educate tab 1014 of tab bar 1005 shown in FIG. 19 is selected or activated. The Educate tab 1014 informs the user relative to the differences provided by the client interaction management system 200 with respect to client education. In particular, the education phase of the example embodiment provides information related to educational events and collateral resources. The example embodiment also provides a tool chest of interactive assessment tools and timely and relevant social media connectivity for clients.

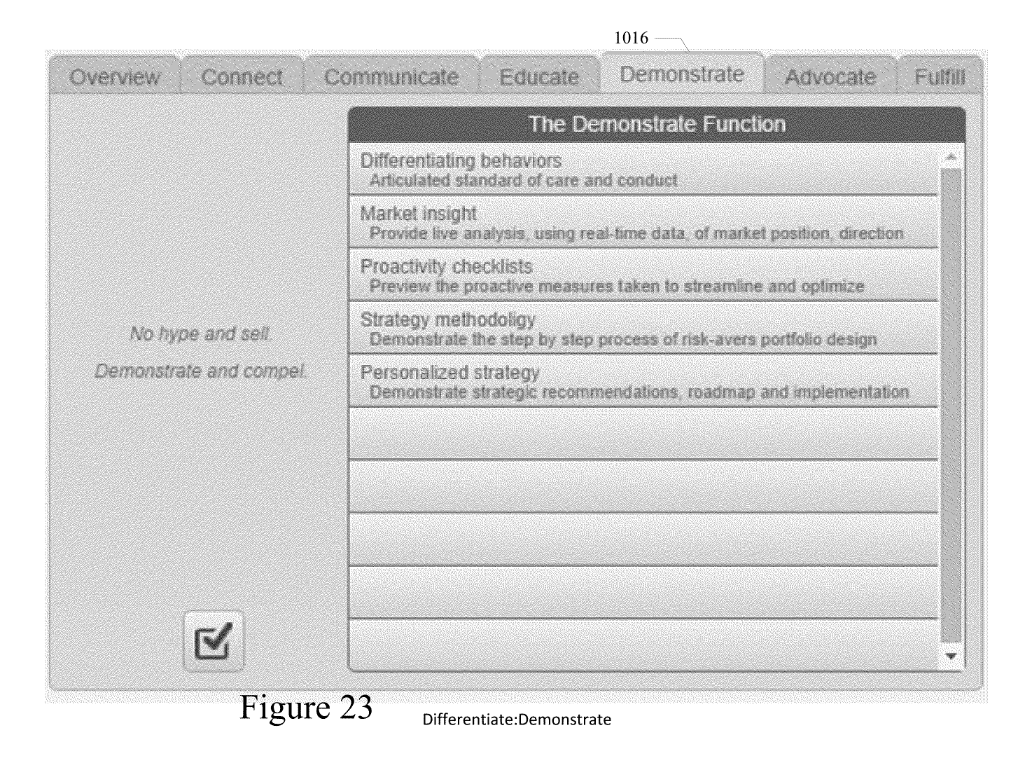

Referring now to FIG. 23, a sample page illustrates the user interface presented to the user when the Demonstration tab 1016 of tab bar 1005 shown in FIG. 19 is selected or activated. The Demonstration tab 1016 informs the user relative to the differences provided by the client interaction management system 200 with respect to client demonstration. In particular, the demonstration phase of the example embodiment provides an articulated professional standard of care and conduct for the client. The example embodiment provides the client with market insight and analysis using real-time market position and direction data. The example embodiment provides the client with proactive checklists and strategy methodologies, which are personalized for the particular client with demonstrated strategic recommendations, roadmaps, and implementation details.

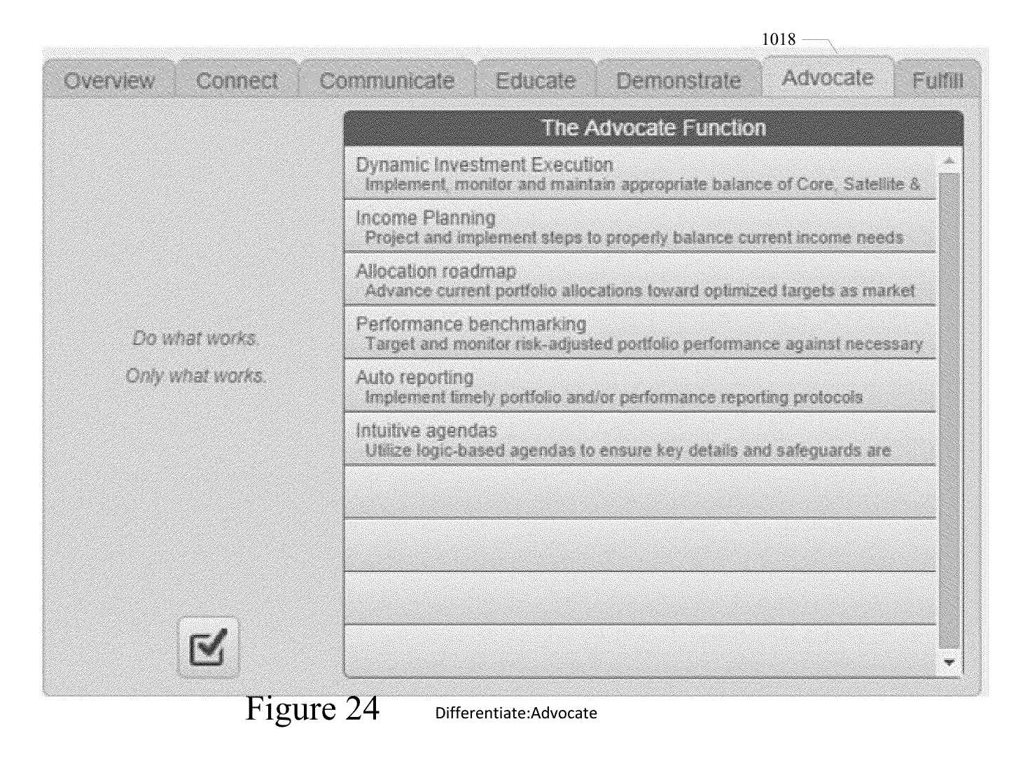

Referring now to FIG. 24, a sample page illustrates the user interface presented to the user when the Advocate tab 1018 of tab bar 1005 shown in FIG. 19 is selected or activated. The Advocate tab 1018 informs the user relative to the differences provided by the client interaction management system 200 with respect to client advocacy. In particular, the advocacy phase of the example embodiment provides dynamic investment education, income planning, asset allocation planning, and performance benchmarking The example embodiment also provides automatic and timely performance reporting and intuitive agendas.

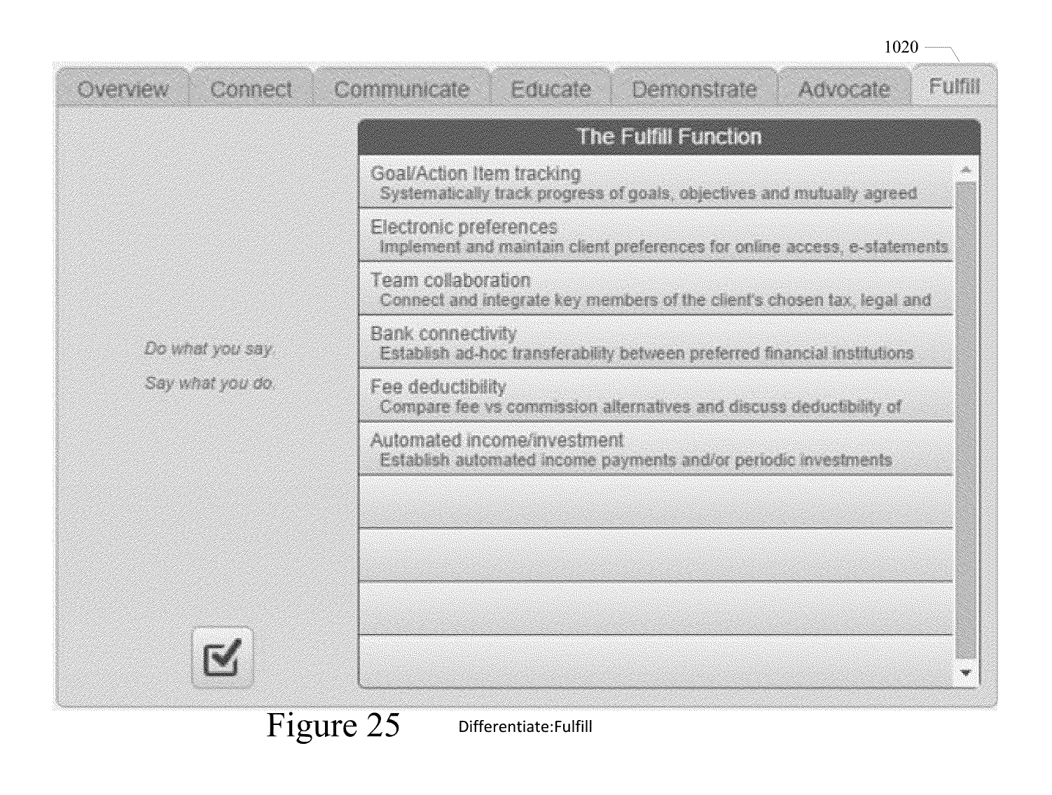

Referring now to FIG. 25, a sample page illustrates the user interface presented to the user when the Fulfill tab 1020 of tab bar 1005 shown in FIG. 19 is selected or activated. The Fulfill tab 1020 informs the user relative to the differences provided by the client interaction management system 200 with respect to client fulfillment. In particular, the fulfillment phase of the example embodiment provides goal and action item tracking The example embodiment also provides on-line access, team collaboration, and automated income and investment transactions. The example embodiment also provides bank or financial institution connectivity and automatic fee deductibility.

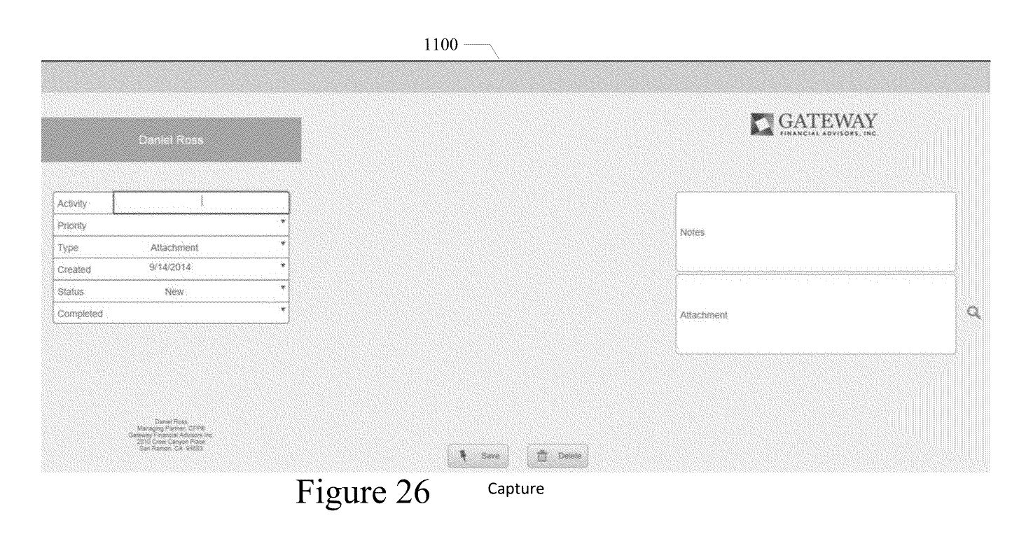

Referring again to FIG. 1, the Capture Control Module 220 of client interaction management system 200 takes control in response to the user activation of the Capture function 320 shown in FIG. 2. The Capture Control Module 220 processes the user input and output related to the Capture function of the example embodiment. The Capture function is described in more detail below in connection with FIG. 26.

FIG. 26 illustrates a sample page 1100 of a user interface presented to a user by the client interaction management system 200 of an example embodiment when the Capture function 320 of the example embodiment is activated. In the example embodiment, the Capture function 320 is generally used to enable an agent to obtain and record client information and to monitor or edit client activities. As shown in FIG. 26, the client information and client activity information can be displayed and/or edited using the provided input objects, dialog boxes, and display areas. The agent can also attach links to a particular client activities. The links can connect a particular client activity to associated documents, emails, webpages, contacts, calendar events, and the like.

Referring again to FIG. 1, the client interaction management system 200 of an example embodiment is also shown to include a Contact To-Do Control Module 240, a Contact Module 250, and an Agent To-Do Control Module 260. The Contact To-Do Control Module 240 of an example embodiment enables an agent or a client to manage a list of activities or action items created in the manner described above. The agent or client can view the list of activities or action items and edit or delete any of the activities or action items, given an appropriate level of authorization access. Similarly, the Agent To-Do Control Module 260 of an example embodiment enables an agent to manage a list of agent or agent team activities or action items created in the manner described above. The agent or agent team member can view the list of agent activities or action items and edit or delete any of the agent activities or action items, given an appropriate level of authorization access. The Contact Module 250 of an example embodiment enables an agent or a client to manage a list of contacts or an address book. The agent or client can view the list of contacts or the address book, including the related contact information, and can edit or delete any of the contacts or contact information, given an appropriate level of authorization access.

Referring again to FIG. 1 and as described above, a user platform 141 can include a mobile device on which a mobile application (app) can be executed. An example embodiment 400, implemented as a mobile device app, can be used to support a mobile device user interface for the client interaction management system 200 of an example embodiment. It will be apparent to those of ordinary skill in the art that other embodiments can also be implemented as a web application (app) with one or more webpages or other types of user interfaces. A mobile version of an example embodiment provides a user-friendly interface from which the user can easily view the relevant client information from a mobile device. As described in more detail herein, a mobile software application (app) embodying a mobile version of an example embodiment as described herein can be installed and executed on a mobile device, such as a smart phone, laptop computer, tablet device, or the like. In an example embodiment, a splash screen appears whenever the user opens or launches the mobile application on the mobile device. This splash screen can display a host logo and wallpaper image while opening the login screen or a live feed of processed client information.

User log-in functionality in the mobile app provides a user-friendly user interface in which the user provides the email address and password associated with the user account. If the user does not have an account, the user can create an account from this user interface. The process of creating a user account in an example embodiment is simple and only requires the user to provide the following information: name, surname, e-mail address, and password. By completing this information, the user can create an account and get access to processed client information.

Referring again to FIG. 1, the client interaction management system 200 of an example embodiment is also shown to include a user account management module 270. The user account management module 270 can be used to create and maintain a user account on the host site 110. The user account management module 270 can also be used to configure user settings, create and maintain a user/user profile on host site 110, and otherwise manage user data and operational parameters on host site 110. In the example embodiment described herein, a user can register as an identified user in order to share information, documents, communications, or other content. The registered user can enter their name, email address, and password. Once this information is entered, a user account is created and the user can share information, documents, communications, or other content.

Referring again to FIG. 1, the client interaction management system 200 of an example embodiment is shown to include an administrative management module 280. The administrative management module 280 can be used by an agent or administrator of the client interaction management system 200 to manage user accounts and to manage the client interaction management system. The administrative management module 280 can also be used to enforce privacy protections and content controls for users. Moreover, the administrative management module 280 can also be used to generate and/or process a variety of analytics associated with the operation of the client interaction management system 200. For example, the administrative management module 260 can generate various statistical models that represent the activity of the community of users and related clients, agents, agent team members, affiliates, and the like. These analytics can be shared, licensed, or sold to others.

Although the various user interface displays provided by the example embodiments described herein are nearly infinitely varied, several sample user interface displays and sequences are provided herein and in the corresponding figures to describe various features of the disclosed embodiments. These sample user interface displays and sequences are described herein and in the accompanying figures. It will be apparent to those of ordinary skill in the art that equivalent user interface displays and sequences can be implemented within the scope of the inventive subject matter disclosed and claimed herein.

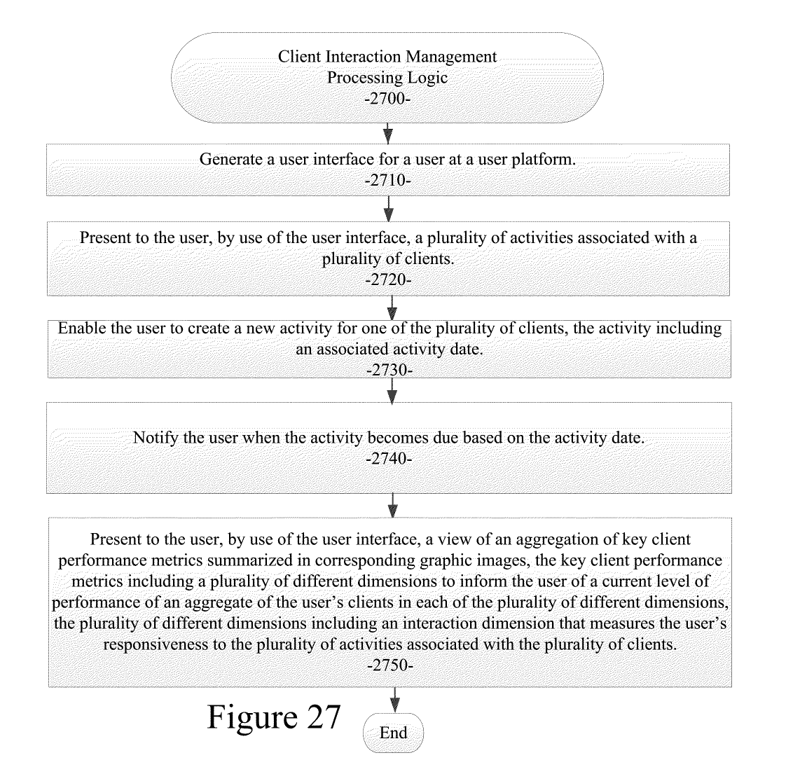

Referring now to FIG. 27, a processing flow diagram illustrates an example embodiment of a client interaction management system 200 as described herein. The method 2700 of an example embodiment includes: generating, by a data processor, a user interface for a user at a user platform (processing block 2710); presenting to the user, by use of the user interface, a plurality of activities associated with a plurality of clients (processing block 2720); enabling the user to create a new activity for one of the plurality of clients, the activity including an associated activity date (processing block 2730); notifying the user when the activity becomes due based on the activity date (processing block 2740); and presenting to the user, by use of the user interface, a view of an aggregation of key client performance metrics summarized in corresponding graphic images, the key client performance metrics including a plurality of different dimensions to inform the user of a current level of performance of an aggregate of the user's clients in each of the plurality of different dimensions, the plurality of different dimensions including an interaction dimension that measures the user's responsiveness to the plurality of activities associated with the plurality of clients (processing block 2750).

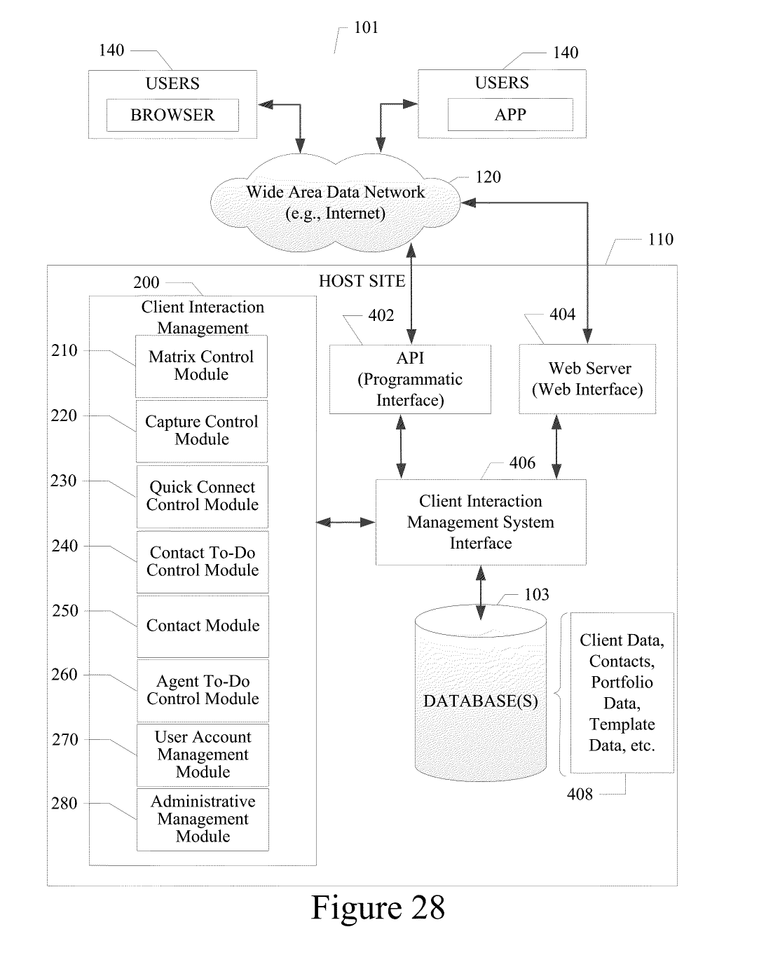

Referring now to FIG. 28, another example embodiment 101 of a networked system in which various embodiments may operate is illustrated. In the embodiment illustrated, the host site 110 is shown to include the client interaction management system 200. The client interaction management system 200 is shown to include the functional components 210 through 280, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the client interaction management system 200 either directly or via an interface 406. The client interaction management system 200 may be configured to access a data storage device 103 and data 408 therein either directly or via the interface 406.

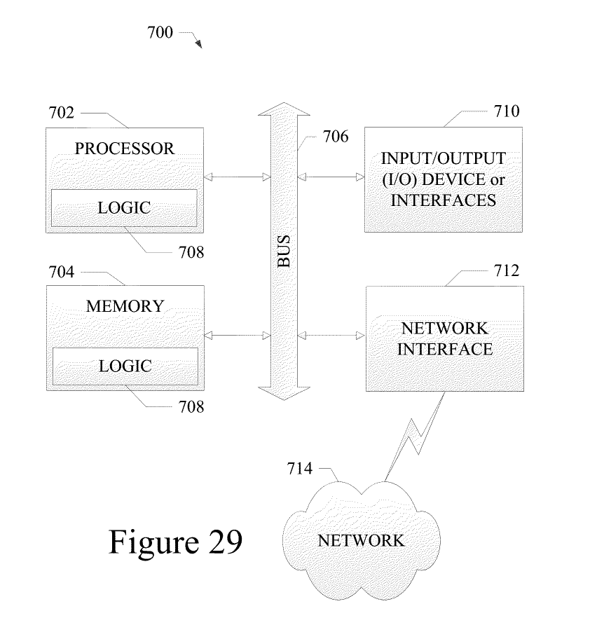

FIG. 29 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
generating, by a data processor, a user interface for a user at a user platform;
presenting to the user, by use of the user interface, a plurality of activities associated with a plurality of clients;
enabling the user to create a new activity for one of the plurality of clients, the activity including an associated activity date;
notifying the user when the activity becomes due based on the activity date; and
presenting to the user, by use of the user interface, a view of an aggregation of key client performance metrics summarized in corresponding graphic images, the key client performance metrics including a plurality of different dimensions to inform the user of a current level of performance of an aggregate of the user's clients in each of the plurality of different dimensions, the plurality of different dimensions including an interaction dimension that measures the user's responsiveness to the plurality of activities associated with the plurality of clients.

2. The method as claimed in claim 1 further including enabling the user to link the activity to associated documents, emails, webpages, contacts, or calendar events.

3. The method as claimed in claim 1 wherein the user platform is of a type from the group consisting of: a desktop computer, a mobile computing device, and a mobile phone.

4. The method as claimed in claim 1 wherein the plurality of different dimensions are from the group consisting of: connection, interaction, adoption, and sustainability.

5. The method as claimed in claim 1 wherein the plurality of different dimensions include an adoption dimension to provide a set of metrics that measure the degree to which the user's aggregated clients have adopted the strategies and actions proposed by the user.

6. The method as claimed in claim 1 wherein the plurality of different dimensions include an adoption dimension to provide a set of metrics that measure the degree to which the user's aggregated clients are on track to meet their goals.

7. The method as claimed in claim 1 further including enabling the user to configure and use client-specific communication templates providing customized client communication content based on a user-selected sender role and a user-selected message tone.

8. The method as claimed in claim 7 wherein the client-specific communication templates are associated with a particular individual client, a particular client group, or a particular client category.

9. The method as claimed in claim 1 wherein any of the plurality of activities can be prioritized with a user or system assigned priority and an associated current status.

10. The method as claimed in claim 1 further including enabling the user to view differentiation information in a plurality of phases including: connection, communication, education, demonstration, advocacy, and fulfillment.

11. A system comprising:
a data processor;
a network interface, in data communication with the data processor, for communication on a data network; and
a client interaction management system, executable by the data processor, to:
generate a user interface for a user;
present to the user a plurality of activities associated with a plurality of clients;
enable the user to create a new activity for one of the plurality of clients, the activity including an associated activity date;
notify the user when the activity becomes due based on the activity date; and
present to the user, by use of the user interface, a view of an aggregation of key client performance metrics summarized in corresponding graphic images, the key client performance metrics including a plurality of different dimensions to inform the user of a current level of performance of an aggregate of the user's clients in each of the plurality of different dimensions, the plurality of different dimensions including an interaction dimension that measures the user's responsiveness to the plurality of activities associated with the plurality of clients.

12. The system as claimed in claim 11 being further configured to enable the user to link the activity to associated documents, emails, webpages, contacts, or calendar events.

13. The system as claimed in claim 11 wherein the user platform is of a type from the group consisting of: a desktop computer, a mobile computing device, and a mobile phone.

14. The system as claimed in claim 11 wherein the plurality of different dimensions are from the group consisting of: connection, interaction, adoption, and sustainability.

15. The system as claimed in claim 11 wherein the plurality of different dimensions include an adoption dimension to provide a set of metrics that measure the degree to which the user's aggregated clients have adopted the strategies and actions proposed by the user.

16. The system as claimed in claim 11 wherein the plurality of different dimensions include an adoption dimension to provide a set of metrics that measure the degree to which the user's aggregated clients are on track to meet their goals.

17. The system as claimed in claim 11 being further configured to enable the user to configure and use client-specific communication templates providing customized client communication content based on a user-selected sender role and a user-selected message tone.

18. The system as claimed in claim 17 wherein the client-specific communication templates are associated with a particular individual client, a particular client group, or a particular client category.

19. The system as claimed in claim 11 wherein any of the plurality of activities can be prioritized with a user or system assigned priority and an associated current status.

20. The system as claimed in claim 11 being further configured to enable the user to view differentiation information in a plurality of phases including: connection, communication, education, demonstration, advocacy, and fulfillment.

21. A non-transitory machine-useable storage medium embodying instructions which, when executed by a machine, cause the machine to:
generate a user interface for a user;
present to the user a plurality of activities associated with a plurality of clients;
enable the user to create a new activity for one of the plurality of clients, the activity including an associated activity date;
notify the user when the activity becomes due based on the activity date; and
present to the user, by use of the user interface, a view of an aggregation of key client performance metrics summarized in corresponding graphic images, the key client performance metrics including a plurality of different dimensions to inform the user of a current level of performance of an aggregate of the user's clients in each of the plurality of different dimensions, the plurality of different dimensions including an interaction dimension that measures the user's responsiveness to the plurality of activities associated with the plurality of clients.

22. The machine-useable storage medium as claimed in claim 21 being further configured to enable the user to link the activity to associated documents, emails, webpages, contacts, or calendar events.

23. The machine-useable storage medium as claimed in claim 21 wherein the user platform is of a type from the group consisting of: a desktop computer, a mobile computing device, and a mobile phone.
